(19) United States
(12) Patent Application Publication
(10) Pub. No.: US 2026/0086663 A1
(43) Pub. Date: Mar. 26, 2026

(54) INDUCTIVE CODE DETECTION

(71) Applicant: AZOTEQ HOLDINGS LIMITED, Nicosia (CY)

(72) Inventors: Frederick Johannes BRUWER, Paarl (ZA); Daniel Barend RADEMEYER, Paarl (ZA); Wikus WOLMARANS, Paarl (ZA)

(21) Appl. No.: 19/341,018

(22) Filed: Sep. 26, 2025

(30) Foreign Application Priority Data
Sep. 26, 2024 (ZA) 2024/07322
Nov. 8, 2024 (ZA) 2024/08461

(51) Int. Cl. G06F 3/0362; G01D 5/20

(52) U.S. Cl. CPC G06F 3/0362; G01D 5/2053

(57) ABSTRACT

Using inductive measurements to detect and measure rotary or linear motion of a movable member wherein both a normal movement is measured as well as a serial number or identification code that is embedded in a pattern. Exemplary applications are watch faces, headphone bezels, camera lenses or flashlight bezels.

### CROSS-REFERENCE TO RELATED APPLICATION

The present application claims priority from South Africa applications ZA 2024/07322, filed Sep. 26, 2024 and ZA 2024/08461, filed Nov. 8, 2024, contents of which are hereby incorporated by reference into this application.

### BACKGROUND

The use of movable members (for example bezels or knobs) as a user interface in electronic devices to adjust product settings or parameters is well known in the art and more specifically, the use of inductive sensing to detect such movement is extensively covered in U.S. Pat. No. 11,624,633 B2 which shares inventors with the present invention.

Inductive measurements compete with other sensing technologies such as Hall rotation, capacitive and optical-type measurements. The invention described in this specification extends the function offered beyond the measurement of movement steps or degrees. It allows for the detection of one or more codes associated with a specific movable member using the same inductive motion sensor without impacting the detection of the normal interval changes as the movable member is moved.

### SUMMARY OF THE INVENTION

An object of this invention is to provide a user interface that uses inductive means to derive not only information regarding the movement (speed, acceleration, distance, position, number of interval changes, etc.) of the movable member as is known in the art but also to detect at least one unique identification code associated with the movable member. Advantageously, this enables a user to replace the movable member with another movable member that has a different set of codes, thereby activating a different set of functions and/or features. Furthermore, this code or set of codes may be used by the main device to verify the authenticity of the movable member that is attached, and to keep count of how many times the particular moveable member has been attached. Furthermore, the code or set of codes may be used to determine if the particular moveable member is valid for use with the device it is attaching to or not. While the embodiments shown herein mostly discuss rotary movement, it shall be appreciated that the embodiments disclosed herein may easily be extended to linear movement of a movable member.

An example of the above scenario is a smart watch with a removable bezel. The user may rotate the bezel to, for example, cycle through a menu of items on the smart watch. The user may further detach the bezel from the watch body and replace it with another bezel that has a different color or shape. In this instance, the watch may automatically detect the new bezel and load a new watch face that suits the new bezel, or change/activate other unique functions on the smart watch that are uniquely accessible only through the new bezel. The watch may further, upon reading the unique code or codes of the new bezel, determine whether said bezel is authentic or not as a measure of rejecting counterfeit bezels. The watch may also, by using the code or codes of the bezel, determine if the bezel is valid for use, i.e. is the bezel allowed to be used with this particular watch, thus avoiding compatibility issues.

Another example is for an electronic camera, where the camera body may have attached to it a lens that is rotatable. Rotation of the lens may provide a zoom function. However, the user may swap out the lens for another type of lens, for example a wide-angle lens. If the wide-angle lens is outfitted with a unique code or set of codes, the camera may automatically detect which lens is attached and load a new configuration that is suitable for the wide lens instead, without the need for a user to manually load new settings on the camera to suit the lens. Moreover, the camera may determine the authenticity of the lens by its code or codes, and reject a lens that does not have a code or code set that matches a known list, thereby avoiding counterfeits and also avoiding the use of lenses that are not compatible (or not valid) with the specific camera, as determined by the manufacturer.

Yet another example is for an electronic toothbrush, where the brush heads are detachable from the main toothbrush body. More than one type of brush head may exist, for example varying in brush firmness or brush pattern. In this instance, the brush heads may each be outfitted with a unique code or codes, so that when they are attached to the main toothbrush body, the toothbrush may obtain various information about the attached brush head. For example, the main toothbrush can, upon reading the code or codes of the brush head, determine its authenticity, as noted for the aforementioned examples. The main toothbrush body may further activate a specific set of functions or load a predetermined configuration that is specifically designed to work with the now attached brush head, which may be, for example, a specific vibration pattern. The main toothbrush may also, upon detecting the code or codes of the brush head and thereafter, update a counter to keep track of how many times the specific brush head was attached and how many times (or hours) the brush head was used in order to notify the user of a replacement that is due. Because the same inductive sensors that read the code or codes, are also used for movement sensing, the rotating or linear movement of the brush head may, for example, change the speed of brush movement upon movement of the brush head itself. All the examples mentioned here for the toothbrush example, including tracking the time of usage, are applicable to the aforementioned watch bezel and camera examples.

A further example is, for example, an electric screwdriver, where different tool heads may be attached to and detached from the main tool body. The different tool heads may differ in property, like for example the material it is made of or the type of tool (Phillips or flat head). If the tool heads contain a pattern with at least a first and second embedded code, the tool body having a coil set can detect when a tool head is attached, perform a first identification by reading the first code upon attachment and load a specific set of functions in response to the identification, and perform a second identification after the user has rotated the tool head to determine the tool head's authenticity, validity or compatibility. The tool head may be rotated by the user to adjust the operating speed of the tool head, which may also be detected by the coil set by monitoring the number of interval changes and movement direction of the pattern. Normally an interval change corresponds to the smallest element in the pattern.

A person of ordinary skill in the art shall appreciate that the aforementioned technology has a much wider base of applicability, where the movement information (speed, acceleration, distance, position, number of interval changes, etc.) of a movable member may be used to adjust a power level of the main device or adjust the screen brightness of the device, while several properties of the movable member itself are revealed using the same sensor system that obtains the movement information of the moveable member.

In accordance with this invention, the rotating or linear movement functions commonly associated with inductive sensing, as well as identification of removable moving members by their code or codes are achieved with the same sensor system. Prior art teachings with these functions typically require separate sensor systems to achieve these functions.

It is well-known in the art that a single set of inductor coils in the form of, for example, planar coils on a printed circuit board, may be used to monitor the rotation (or linear motion) of a movable member. This is achieved by placing said coils in such a manner that the movement of the movable member interferes with the magnetic field of the inductors in a predictable and regular manner, thereby changing their inductance. The latter inductance change is measurable by a suitable measurement circuit, such as an integrated circuit (IC) device, which alone, or together with a processor, then determines the degree, speed, position and other characteristics relating to the movement or position of the movable member.

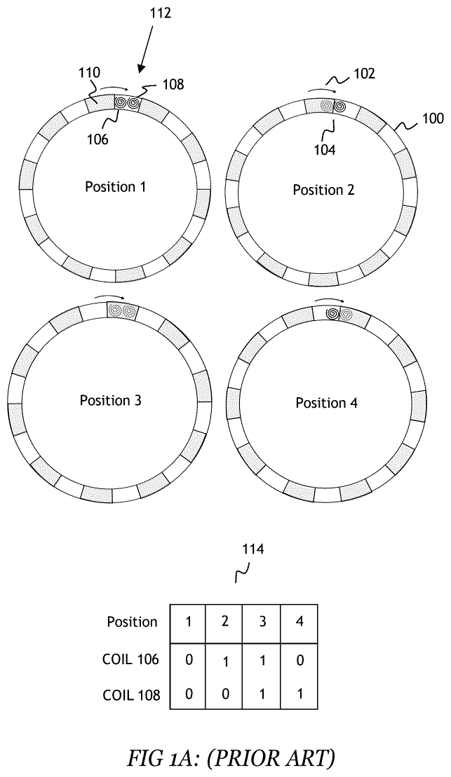

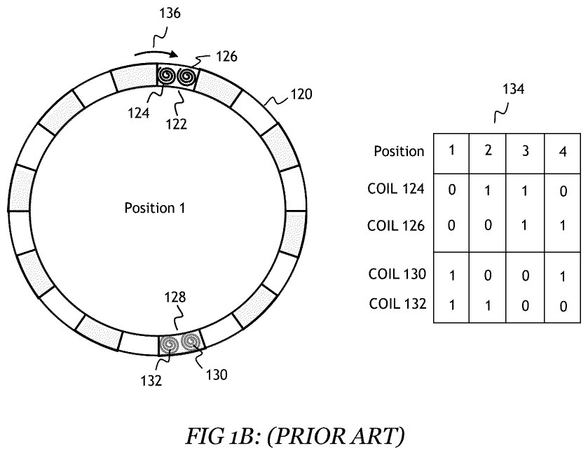

It is typical for the movable member to have a plurality of inductance interfering elements that are arranged in a pattern, such as what is shown in FIGS. 1A and 1B (described later in this specification). Said pattern typically comprises regular (or repeating) intervals of the inductance interfering elements, which may be understood as the ‘tick’ points of the movable member, and the size and density of these interfering members contribute to the resolution of the sensed motion, i.e. how many ‘tick’ points or intervals are detectable. Smaller interfering members may be placed in a denser pattern leading to a high rotation or movement resolution (a high ‘tick’ count or high interval count), and vice versa.

In accordance with this invention a code or codes can be embedded in the pattern formed in or on the movable member's surface whilst still measuring and detecting interval changes in an uninterrupted way. This means there is no discontinuity in the normal movement detection. It is advantageous to use inductive sensing compared to Hall effect sensing since no magnets are required to perform inductive sensing, but may nonetheless be included for further benefits as described later in this invention. A further advantage is that if the device, like a smartphone or smartwatch, uses magnetic sensors to measure the earth's magnetic field for a compass function, magnets can disrupt this function and must be avoided, which makes the present invention ideal to use.

In a first embodiment, two sets of two inductive coils are used. Said coils may be placed on a printed circuit board (PCB), which is further attached to a main body such as, for example, a smart watch body or a camera body or even an electric toothbrush body. A movable part or member, which may for example be a smart watch bezel, camera lens or brush head, is designed to have a plurality of inductance interfering elements that form a pattern. The pattern is then divided into two sections: a regular pattern section (or regular section) and a code pattern section (or code section for short). If the coil sets are placed 180 degrees apart and the regular section covers an angle greater than 180 degrees, then it is guaranteed that at least one coil set will be covered by the regular section. In other words, at least one coil set will always be available to monitor the regular section for the purpose of determining the direction, speed, distance, acceleration or a combination of these properties of the rotating member. By accumulating the detected interval changes, the total rotation distance or interval change count may be determined as well.

An ‘interval change’ or ‘tick’ in this invention may be interpreted as the smallest change in movement of the movable member that is detectable by a coil set. This normally corresponds to the smallest element in the pattern.

In the code section, a code may be embedded using a pulse width modulation (PWM) concept or other protocol that is detectable by the coil set that is not overlapping with the regular section. Because direction information is known from the coil set monitoring the regular section, the code can be unidirectional. The code may also be bidirectional, i.e. the code can be read from the code section when passing over a set of coils in either direction. Because the regular section is always being measured by at least one set of coils, this can also be used to synchronize the measurement/detection in the code section.

A key point of the invention is that rotation (or linear motion) can continuously and accurately be measured using the regular section and an identification code or codes can be embedded in the code section of the movable member for simultaneous measurement through a second set of inductive coils. For inductive measurements, the regular and coded patterns can be formed by a plurality of inductance interfering elements, where the interfering elements may be made of highly permeable materials, such as soft ferrite or highly electrically conductive materials, such as aluminum or copper. Highly permeable materials enhance the coils'inductance in a measurable manner, whereas the electrically conductive materials suppress the inductance through eddy current losses and is also measurable. Thus, both approaches are suitable for the regular section and for the code section.

The movable member itself may be made entirely of highly permeable or electrically conductive material; the latter being preferred. If the movable member is made of an electrically conductive member such as aluminum, the plurality of inductance interfering elements may be implemented by cutting away some of the surface of the movable member to form the regular section and the code section. The remaining protruding parts (or ‘teeth’) may then be regarded as the inductance interfering elements. The sizing of the interfering elements can be made to match the area of the coils so that when an interfering element aligns with a first coil in the coil set, maximum inductance change occurs and thus maximum signal is achieved, while also minimizing interference with the nearby second coil in the coil set. Furthermore, the cutaway areas can also be filled with highly permeable material, such as ferrite sheets, which further increases the signal range measurable from each coil. The latter case causes the cut-away areas to become ‘reverse interfering’ elements. It may be the case that the cut-away areas still affect the coils in the coil set, but not as much as the protruding parts, in which case the cut-away areas may still be regarded as ‘non-interfering’ elements relative to the protruding parts.

In applications such as smart watches or electronic cameras, it is expected that the PCB coils will have a relatively small area (4 to 9 square millimeters), even when routed on the top and bottom layer of a PCB. As a result, the reference inductance may be low, which may complicate the inductive measurement circuitry. For example, if an LC-tank measurement technique is used, a too small inductance requires an excessively large capacitor component to meet an ideal oscillating frequency for the measurement. In this regard, a highly permeable material, preferably ferrite sheet due to its cost-effectiveness and low profile, may be attached to the bottom layer of the coil PCB, to increase the reference inductance to a desired range. The top layer of the PCB coil may still be subject to influence by the inductance interfering elements of the movable member. Furthermore, if the main body is made of electrically conductive material, for example an aluminum watch body, then adding the permeable material to the bottom of the PCB coil before attaching it to the main body protects the coil's magnetic field against being suppressed by the main member.

As the different inductance interfering elements (including air of the cutaway areas) of the movable member move over the coils this can be recognized from the measured inductance. A binary approach may be taken, where a ‘0’ means that a ‘cut away’ area of the rotating member is currently overlapping with the coil monitored. Similarly, a ‘1’ may be assigned by the measurement device if sufficient change in inductance has occurred for the measured coil. This may, for example, be determined by means of a predetermined threshold, as is known in the art. In other words, a ‘1’ may be assigned when a protruding or other type of interfering element overlaps with a coil such that the inductance has increased (when permeable material is used) and the related measured value on the IC breaches a predetermined threshold, or decreases (when an electrically conductive material is used) and breaches a predetermined threshold. A ‘0’ may then be assigned if no threshold is breached. The threshold itself may be determined by the designer or user to best discern a rotation event from signal noise. This binary approach implies that the code or codes embedded in the patterns of movable members may be comprised of ‘0’s and ‘1’.

Provisions may be made to ensure environmental stability. It is known in the art that sensors, including inductive sensors, are susceptible to changing environmental conditions. To this extent, it is noted that the differential inductances between the coils within a coil set and between coil sets may be calculated or directly measured using appropriate measurement circuitry, for the measurement IC or the MCU (processor) controlling the IC to discern rotation or movement events (or interval changes) from environmental events. Likewise, the ratio values of coils relative to each other may be obtained by measurement or calculation for the same purpose. Said differential values and/or ratio values may be compared to their own thresholds to assign a ‘0’ or a ‘1’.

The code section may have a start marker at the beginning of the code section, and an end marker at the end of the code section. This may take the form of, for example, a set of inductance interfering elements that make up 2-bit, 3-bit or longer sub-code section that cannot be found consecutively in the regular section. As a further example, if the regular section has the pattern . . . 001100110011 . . . then a possible start marker in the code section would be ‘101’ and a possible end marker would be ‘010’, since neither of these sequences is found in the regular section. Furthermore, if the IC stores the history of the previous bits observed by each coil, then the history along with the current reading can be used by the IC to detect the start or end marker. Additionally, this may be used by the IC to recognize which coil set must be used to read the code, and which set to use for rotation or other movement monitoring. Having dissimilar start and end markers may also be used as a verification of motion direction.

The code can be formed in various ways such as a PWM type protocol that is synchronized with the regular interval transitions. In principle, the user can move the movable member fast or slow or stop intermittently whilst moving the code section over the set coils. As such, the timing is derived from the regular section as measured by the set of coils that opposes the code section.

In another embodiment two code sections can be used and there will also be two regular sections. In context of a rotating member, it may be ensured that at least one set of coils is observing one of the regular sections by requiring that the angle subtended by the code sections (in the use of rotational movement) is smaller than the angle subtended between the coil sets. Furthermore, the angle subtended between the coil sets must be smaller than the angle of the regular sections. As an example, suppose that the angle between the coil set is 100 degrees. Then the angle of each code section may be 70 degrees, and the angle of each regular section may be 110 degrees. The benefit of this embodiment is that the code section is observed by a set of coils more frequently, and so code detection may be made quicker. In an embodiment requiring linear motion monitoring, the angle mentioned above may be understood simply as distance or length. For example, if the distance between the coils is 100 mm, then the code sections may be 70 mm in length each while the regular sections may be 110 mm in length each.

In a further embodiment, three coils can be used in a single set of coils for simultaneous code and movement detection. Unlike the aforementioned embodiments, the code is embedded into the general pattern section that has subsections, and a single marker may be required to denote the start and end of said general pattern. Each subsection may have a first bit “1” or “0”, and last bit that is the opposite of the first bit, and the second (or middle) bit is the payload bit. For example, the movable member may have 10 sections (each of 3 bits) and thus 30 bits. A single bit change that happens during a rotation is detectable (an interval change) and thus this embodiment has a resolution of 30 “ticks” not accounting for the marker. This embodiment has 10 payload bits, allowing for 2¹⁰ unique codes for movable members to use. The first bit for every section must be the same, and the last bit of every section must be the same. For instance, a “1” may be assigned to every first bit and “0 ” for every last bit. An example pattern will then be 110 110 100 110, having 4 sections with a unique code 1101 (the middle bits) and thus 2⁴ unique code possibilities. This philosophy allows the payload to be identified on the second coil, if the first coil registers a “1” and the third coil registers a “0”. A benefit of this approach is that no synchronization is required with another coil set since there is only one set. Another benefit is that the number of unique codes possible is fairly high. However, a full rotation or a full length of linear motion is required to extract the entire unique code, but may not be necessary if a shorter code is sufficient for further use.

Another advantage of the aforementioned embodiment is that since every section at least contains a “1” and a “0”, the data can be interpreted using differential measurements, i.e. the absolute values are not important and as such, environmental changes have less effect.

A further challenge with detecting interchangeable movable members that have identification codes is when said detection is required directly after a powered-down state. In this scenario, the location of the code is unknown relative to the coils and up to a full rotation or a full length linear motion may be required before the code can be determined with certainty. An exemplary embodiment is proposed wherein the code together with a delimiter may be repeated to form a regular pattern, which avails the code to be read multiple times during a rotation or linear motion. This minimizes the angle of rotation (or distance of movement) required for movable member identification from an unknown state.

The abovementioned embodiments all require the movable member to be moved in order to read the code. While feasible, it creates algorithmic complexity for handling edge cases, for example when the user stops while the code is being read and rotates (or moves) the member in the reverse direction. A good solution would be to read the code when the movable member is inserted into or attached onto its main body (at the time of attachment), without the need for any movement. In addition to addressing algorithmic complexity, it provides the benefit of improved user experience since the code is detected quicker. To this end, an exemplary embodiment is disclosed that utilizes a mechanical restriction such that the movable member may only be inserted into or attached onto the main body in a specific way (or ways) that ensures the a predetermined code or codes are matched with the coil set, thereby ensuring that the coil set always detects a predetermined code upon attachment, since the code may be mechanically aligned relative to the mechanical restriction. In this case, the movable member and the main body may be said to be a keyed pair, wherein there may exist more than one predetermined way to attach the movable member to the main body to avail different predetermined codes at the time of attachment.

An obvious shortcoming of the method of mechanical restriction is the possibility of an accidental detachment. If, for example, a mechanical slotted method is used for member attachment or insertion onto or into a main body, it may occur during normal use that the movable member is accidentally detached when it aligns with the original position of insertion or attachment. To prevent such an occurrence, a latching mechanism may be used by the main body to keep the movable member attached to or inserted into said receiving body.

A non-latching alternative to the latching mechanism would be, for example, the use of magnets. It should be noted that while one of the aims of this invention is to provide an alternative to magnetic sensors, the limited use of magnets may still serve as beneficial to the invention. Prior art such as US20250044878A1 and U.S. Pat. No. 10,278,288B2 disclose how magnets can be detected by inductive coils with the use of a magnetic material such as ferrite. It follows that when the magnet is near ferrite, it becomes saturated. This saturation may be detected by the inductive coil if the coil's magnetic field also passes through the ferrite. An example embodiment would then include at least one magnet instead of a protruding metal tooth on the movable member, and also a second magnet in the main body. When the movable member is inserted into or attached onto the receiving body using the slots on the main body, the magnet in the rotating member and the magnet in the main body form an attraction force that keeps the movable member in place after attachment or insertion, without the need for a mechanical latching mechanism as disclosed earlier. If the inductive coils are supplemented with magnetic material, both the magnet in the movable member and the regular metal pattern will disrupt their magnetic field, thereby still enabling normal inductive sensing and by extension, code reading.

In another exemplary embodiment, the use of a single magnet may serve the purpose of noting a specific position, for example the 12 o'clock marker on a removable watch bezel, which is not achievable using only metal targets. In this embodiment, an extra coil may be placed separate from the coil set and may be designated as a marker coil. This coil may have a permeability covering (for example ferrite) on its top layer so as to remain shielded from the influence of conductive targets on the rotating member, and susceptible only to the magnet. In this way, if the magnet is placed at the 12 o'clock position on the rotating member, this position may be confirmed by the IC when the magnet passes over the marker coil, further allowing the IC to automatically recalibrate the true position of the movable member relative to the main body, and to determine the absolute position of the movable member relative to the main body.

The above-mentioned embodiments have been explained to have a single code that is readable at time of attachment, or by rotating of the member. It follows that any of the above embodiments may be configured to perform a first identification or function(s) as a result of reading a first code, said first code being any part of the pattern and not necessarily a dedicated part of the pattern, at the time of attachment. Then, when the movable member is rotated or moved relative to the main body, for example directly after the first identification, the code sequences read after each interval change may form a second code that is longer than the first. The second code may then be used to perform a second identification or function(s). A third or more code sequence following the second is also possible.

### BRIEF DESCRIPTION OF THE DIAGRAMS

FIG. 1A—Two coil relative rotation detection (Prior Art).

FIG. 1B—Two sets of two coils for relative rotation detection (Prior Art).

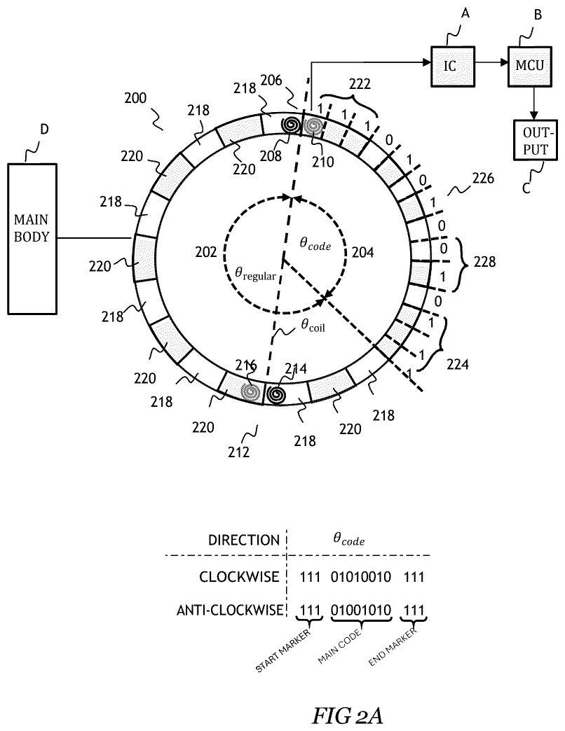

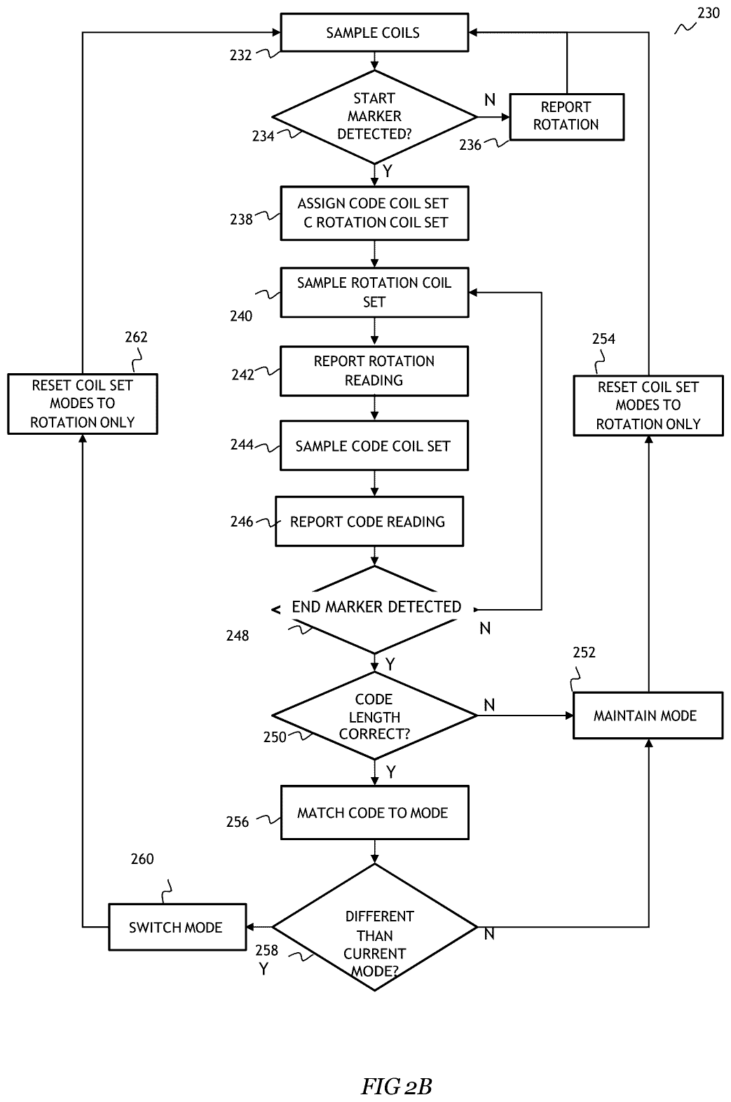

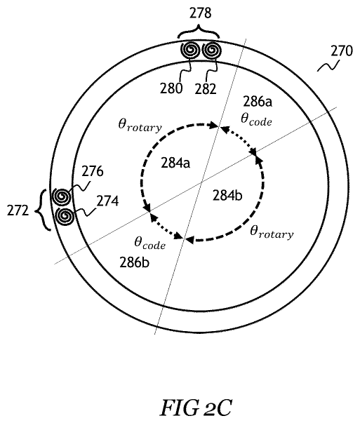

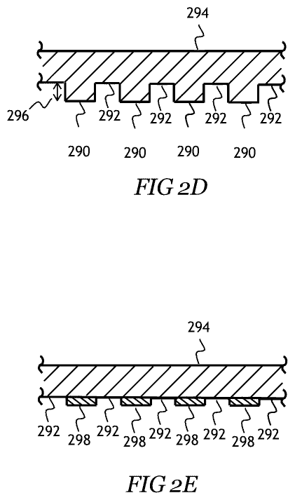

FIG. 2A—A rotating member with a separate regular interval section and a code section.

FIG. 2B—Flow diagram of a rotating member with a separate regular interval section and a code section.

FIG. 2C—Two sets of two coils with smaller subtended angle.

FIG. 2D—Side sectional view of rotating member with teeth-like interfering elements.

FIG. 2E—Side sectional view of rotating member with using two materials.

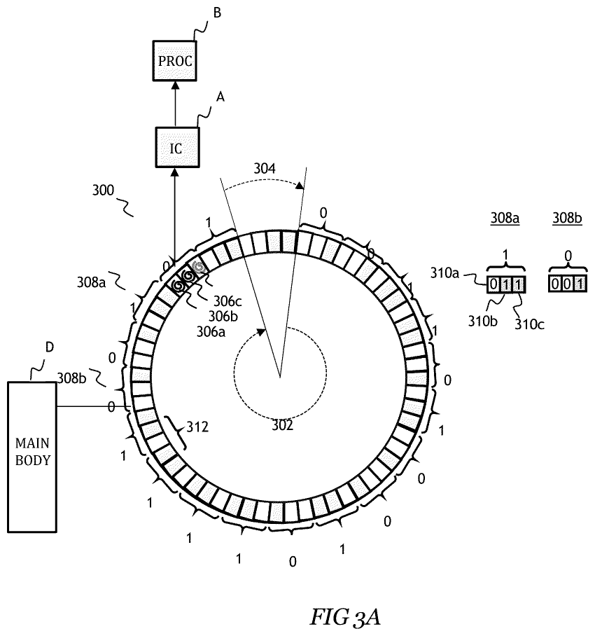

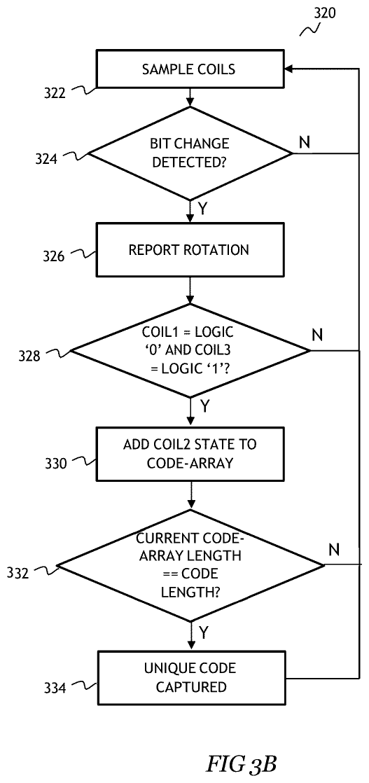

FIG. 3A—Three bit-style embedded code and rotation detection.

FIG. 3B—Exemplary algorithm to extract an embedded code from a regular interval.

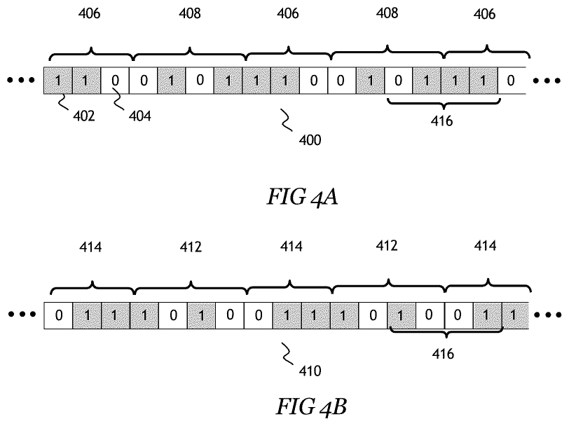

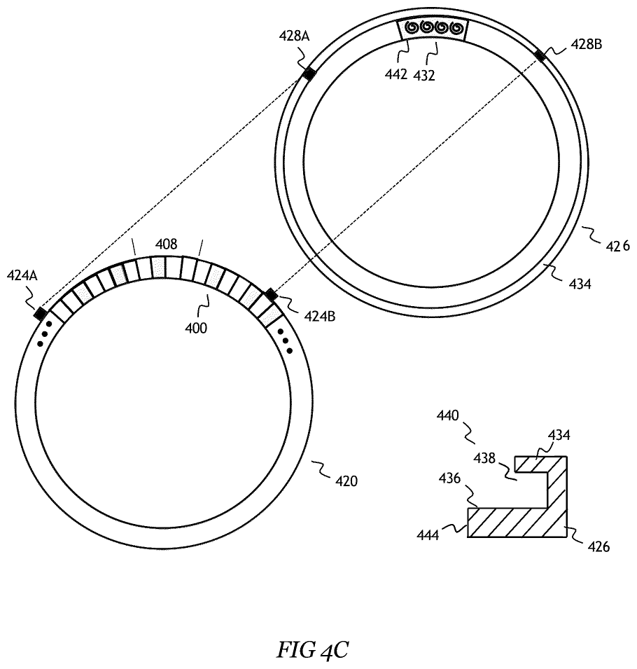

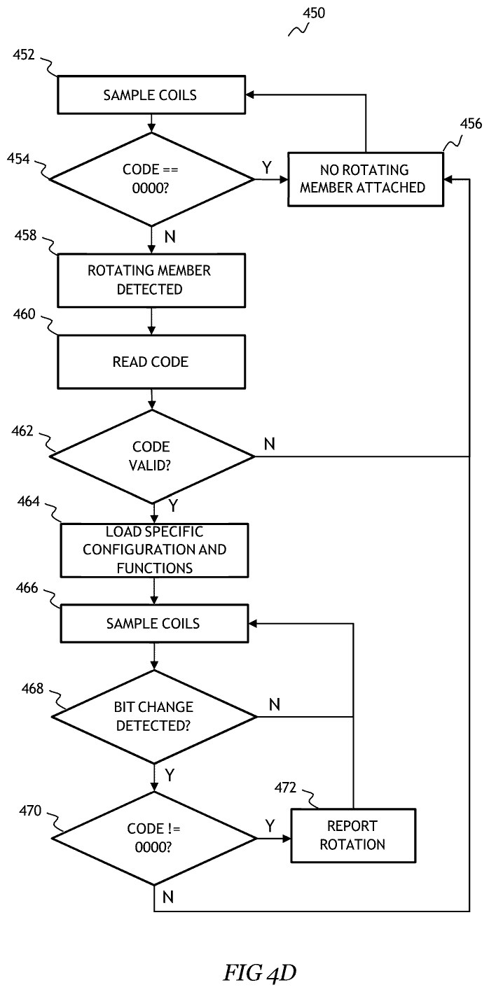

FIG. 4A—An exemplary regular interval comprising a code and delimiter.

FIG. 4B—An exemplary embodiment of a different unique code with a delimiter.

FIG. 4C—Mechanical attachment of a rotating member onto a main body.

FIG. 4D—Algorithm to perform rotation detection, rotating member detection and code detection.

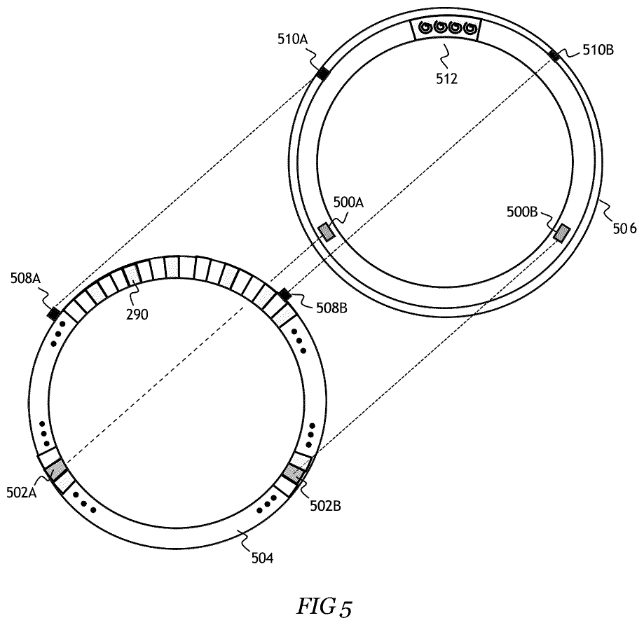

FIG. 5—Using magnets for rotary magnet attraction.

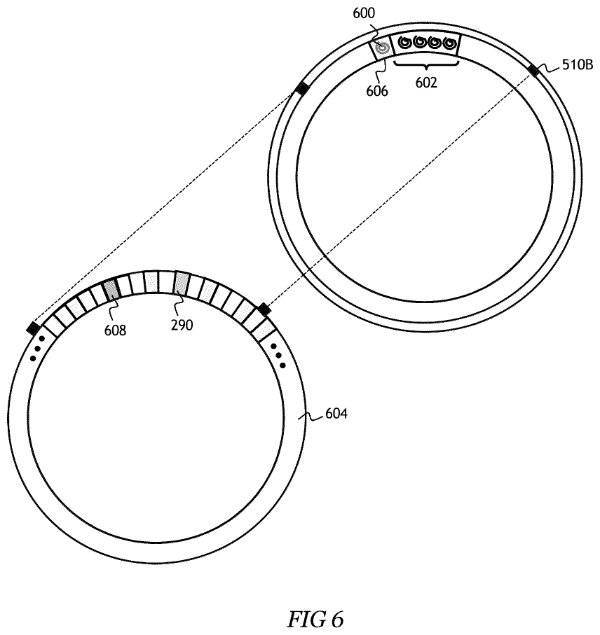

FIG. 6—Using a magnet for absolute position detection.

### DETAILED DESCRIPTION OF THE DIAGRAMS

The diagrams and descriptions are exemplary and not meant to be restrictive. The embodiments shown herein are for rotatory-style interfaces, but these may be adapted for use in linear motion-style interfaces. As such, the use of ‘angle’ herein may mean length or distance for a linear motion embodiment. The use of degrees may likewise be interpreted as millimeters, or any other suitable unit of length. The use of ‘rotation’ may be substituted for ‘movement’ or linear motion in general. A ‘rotatable’ member may be seen as a ‘movable’ member in general for this invention.

FIG. 1A shows a prior art arrangement of how a single set of two coils may be used to detect rotation count (or interval changes) and direction of movement. A top-down view of a rotating member 100 is shown to have four possible positions, where each position is achieved by rotating the rotating member 100 in a direction 102. The rotating member is illustrated as a ring in this instance, but may take other forms, such as for example a disc. A coil set 104 is used to monitor the rotation of rotating member 100, and typically comprises a first coil 106 and a second coil 108. The coils are placed on a stationary member, such as a PCB (not shown). The rotating member 100 has a plurality of inductance interfering elements 110 that are interleaved with non-interfering elements 112. It is common for the interfering elements 110 to have the same arc length as the non-interfering elements 112. It is also common for the interfering elements 110 to span the arc length of the coil set 104.

At position 1, the first coil 106 and the second coil 108 both overlap with a non-interfering element 112. Therefore, the magnetic fields generated by the first coil 106 and the second coil 108 remain unaltered, and so the measurement IC (not shown) connected to coils 106 and 108 measures no change in inductance, and thus a binary state of ‘0’ is assigned to both coils. This state is also indicated by truth table 114. When the rotating member 100 is rotated in direction 102 such that coil 106 is covered by part of an interfering element 110 then if the interfering element is made of an electrically conductive material, such as aluminum or copper, the alternating magnetic field of coil 106 will induce eddy currents on the surface of the interfering element 110, which suppresses the inductance of coil 106. Said suppression is measurable by the measurement IC (not shown). It is common for a measurement IC to have measurement channels assigned to each coil it's monitoring, where the measurement channel itself may display a value that is representative of the coil's inductance. By applying a threshold to the measurement channel value, the suppressive effect on coil 106 at position 2 will reflect in its measurement channel value and breach the threshold. When the threshold is breached, a binary state of ‘1’ is assigned to coil 106, while the state of coil 108 remains ‘0’ as noted by the truth table 114. At position 3, the interfering element completely overlaps with the coil set 104, and so both coils 106 and 108 are assigned a binary state ‘1’. Finally, at position 4 coil 106 becomes unsuppressed and its measurement channel value returns to normal with a binary value of ‘0’, while coil 108 remains suppressed.

It is evident from the truth table 114 that the measurement IC or equivalent circuit can easily determine rotation or interval change or the number interval changes (or ‘clicks’) of the rotating member 100, which is denoted by a binary state change on any coil. Furthermore, since the states of coils 106 and 108 are shown in truth table 114 to be unique for every position, it is possible for the measurement IC or processor to derive the rotation direction. Other information may be extracted from the rotation amount and direction, such as, for example, rotation speed if the time interval between clicks is also measured. Another possibility is rotation acceleration.

Interfering elements 110 may also be made of a highly permeable material, such as ferrite sheet. In this case, the overlapped coil's magnetic field is not suppressed, but enhanced instead, leading to an increase in its inductance. This is observable in the coil's measurement channel value, and may also be compared to a threshold. In this case, an enhancement leading to a threshold breach is assigned a binary state of ‘1’.

Thus suppressive-type interfering elements and enhancing-type interfering elements may be used together on the same rotating member 100 to form a trinary pattern instead, so that a state of ‘0’, ‘1’, or ‘2’ is achievable, as taught in U.S. Pat. No. 10,278,288B2.

Another prior art embodiment is shown in FIG. 1B, and illustrates a top-down view of a rotating member 120 in position 1, with similar features to the embodiment of FIG. 1A. However, this embodiment has a first coil set 122 having a first coil 124 and a second coil 126, as well as a second coil set 128 comprising a first coil 130 and a second coil 132. The coil sets 122 and 128 are positioned such that the binary state of the first coil set 122 is inverted from that of the second coil set 128. This is indicated by truth table 134 when rotating the rotating member 120 in direction 136. This may be beneficial for redundancy reasons, or to perform differential measurements and thereby gain environmental resistance. For example, in this embodiment coil 124 and coil 130 may be regarded as a complementary pair since they will change binary state at approximately the same time when rotating member 120 is rotated. Since they are exposed to the same environment, coil 124 and coil 130 may experience similar signal drift in their measurement channel values on the IC. Then, the IC may rather observe the difference between these coils, either by subtracting their measurement channel values from each other or by analog measurement to obtain a first differential value. Said first differential value will still change as rotating member 120 rotates, but will remain constant during environmental changes as these changes will be common for both coils 124 and 130. The same applies to coils 126 and 132 to form a complementary pair and thus a second differential value. Said first and second differential values may have their own thresholds to denote rotational changes of rotating member 120. Also instead of obtaining a difference within a complementary pair, it may be beneficial to obtain a ratio, i.e. a division operation, between the coils for the same purpose.

A first embodiment of the present invention is shown in FIG. 2A. A rotating member 200 is divided into two sections, namely a regular pattern section 202 with a subtended angle θ_{regular} and a code section 204 with a subtended angle θ_{code}. Furthermore, the embodiment has a first coil set 206 with a first coil 208 and a second coil 210, and also a second coil set 212 with a first coil 214 and a second coil 216. The rotating member is shown in the figure as being a ring, akin to a watch bezel, but may take the form of a solid disc instead, or any other shape that is required to rotate as determined by the application. The first coil set 206 and the second coil set 212 are shown to be 180 degrees apart (θ_{coil}). The angular spacing is not restricted and may be set at a smaller angle. The angles θ_{coil}, θ_{regular} and θ_{code} may be set at any value, as long as θ_{code}<θ_{coil}<θ_{regular}. Having a large θ_{code} is beneficial to have a large number of unique codes to embed into the rotating member 200, but a disadvantage is that it will take longer for a coil set to read the code section 204. Furthermore, the coils 208, 210, 214 and 216 may be in the form of planar wire wound coils, PCB coils, or any inductor capable of emitting its magnetic field in the direction of the rotatable member such that said magnetic fields are susceptible to the rotation of the rotating member 200.

The regular section 202 comprises non-interfering elements 218 and interfering elements 220. As explained in the preceding sections, the interfering elements 220 may be made of an electrically conductive material including but not limited to copper and aluminum, or a highly permeability (typically with a relative permeability of 10 or greater). An example of the latter is ferrite sheet, such as EMI Absorber AB5000HF Series by 3M™. The non-interfering elements may simply be made of any material that has no or little effect on the magnetic fields of coils 208, 210, 214 and 216, or may be physically positioned to have little or no effect.

In an alternative embodiment, the non-interfering elements 218 may also be inductive interfering elements, but with the opposite effect of the interfering elements 220. For example, if interfering elements 220 are made of an electrically conductive material, then the elements 218 may be made of a highly permeable material, or vice versa. This is beneficial since the range of inductive variation that will be observed by the measurement IC A will be much greater than only having one type of interfering element.

The code section 204 also comprises interfering elements, which are simply denoted by a ‘1’ in FIG. 2A for simplicity. The ‘1’ also denotes the binary value that is assigned by the IC when the interfering element passes over whichever one of the coils 208, 210, 214 and 216 is designated to read the code. Similarly, non-interfering elements are denoted by ‘0’. The interfering elements ‘1’ and non-interfering elements ‘0’ in the code section 204 cumulatively make up a unique code, with three subsections, namely a start marker 222, an end marker 224 and a main code 226. The purpose of the start marker 222 and end marker 224 respectively is to announce the start and end of the main code 226 to whichever coil set 206 or 212 encounters it. In this way, the IC A may be informed which coil set may be assigned to monitor normal rotation information given by the regular section 202 of rotating member 200, and which set is responsible for reading and saving the code from section 204. More information of this procedure will be given in FIG. 2B.

The embodiment in FIG. 2A shows that the start marker 222 and the end marker 224 are the same. However, this need not be the case, as a start marker may for example be ‘111’ and the end marker ‘'000’. With dissimilar markers, the measurement IC need not rely on the rotation direction information given by the coil set 206 or 212 monitoring the regular section 202 to correctly read the code. Instead, a coil set 206 or 212 encountering a unique start marker 222 may immediately know the direction of rotation such that the main code 226 is saved in the correct order; this may be regarded as a more elegant solution than having a similar start marker 222 and an end marker 224. There is no restriction on the length or code of the markers 222 and 224 themselves, other than that it is not allowed to appear in the regular section 202 or in the main code 226. The latter restriction is required to avoid false code detections.

In a further embodiment, the inductance interfering elements 218 of the regular section 202 may be selected to be of a first interfering type, for example, electrically conductive elements, while the interfering elements ‘1’ of the code section 204 may be selected to be of a second type of interfering element, for example a highly permeable material. In this way, the detection of the code section 204 is achieved simply from the inductive effect. For example, the measurement IC A may easily distinguish between the regular section 202 and code section 204, because the interfering elements 218 of the regular section 202 may be made of an electrically conductive material which lowers the inductances of whatever coil set 206 or 212 monitors the section 202, while highly permeable elements ‘1’ of the code section 226 tend to increase the inductance of whatever coil set 206 or 212 monitors the code section 204. Thus, the coil set 206 or 212 which experiences an increase in inductance is assigned the duty of reading the code section 204, while the coil set 206 or 212 that experiences a drop in inductance is assigned the duty of monitoring the rotation of member 200. It is clear that this embodiment greatly eases the coil set assignment task of the measurement IC. Furthermore, this embodiment eliminates the need for start and end markers 222 and 224.

Data from the IC A is applied to a processor B which implements appropriate algorithms/calculations and makes data available at an output C in any suitable form e.g. on a display. As is known in the art, IC A and processor B may be the same device.

A flow diagram is presented in FIG. 2B which illustrates an exemplary algorithm 230 for simultaneously detecting the regular section 202 and reading the code section 204. In step 232, the coil sets 206 and 212 are sampled to detect the presence of interfering elements 220. The measurement IC A then evaluates whether a start marker 222 has been detected in step 234. If not, a normal rotation is reported in step 236. Steps 232, 234 and 236 are repeated until a start marker 222 is detected. When a start marker 222 is recognized, the coil sets 206 and 212 are assigned separate roles in step 238. The coil set responsible for detecting the start marker 222 is designated as the code coil set, while the remaining coil set is designated as the rotation coil set. Any rotations that follow are sampled by the measurement IC in step 240 using the rotation coil set, and reported in step 242. Said reporting step may be interpreted as the forwarding of any rotation information (rotation direction, speed, acceleration, amount) to the MCU B, a user interface or another electronic device, or simply to other related functions on the measurement IC itself. Subsequently, the code coil set is read and reported in steps 244 and 246 respectively. It should be noted that steps 240 and 242 may be combined as a single step, and similarly steps 244 and 246 may alternatively be seen as a single step. It is important that step 244 follows as quickly as possible after steps 240 and 242, since the detection of a new binary state in code section 204 is typically synchronized with the detection of a new rotation ‘click’ as illustrated in FIG. 1A. Thus, a code bit is typically saved or reported almost immediately after a registered rotation event. Importantly, this embodiment requires very fine mechanical alignment of the coil sets to ensure this synchronous function.

A check for the end marker 224 is performed at step 248. If an end marker 224 is not found, steps 240 to 246 are repeated. However, if an end marker 224 is found, the code section 204 length may be verified in step 250. The verification of the code section 204 lengths is not mandatory, but useful to make the algorithm 230 more robust. An alternative to verification of the code section 204 length is to verify the main code 226 length instead. If the length is found to be incorrect, the current mode is maintained in step 252 and the coil set modes are reset to monitoring rotation in step 254. Said mode may refer to, for example, a set of features or functions related to the main electronic device. For example, if the main electronic device is a smart watch, then mode may refer to a specific watch face and its accompanying software settings and configuration. Alternatively, if the main electronic device is a camera, then the mode may refer to a suite of settings available to the user that is relevant to the type of lens that is attached. Overall, the term ‘mode’ is a broad term to refer to settings, functions and configurations in the main electronic device's software.

If the code length is correct, the main code 226 is matched to a list of modes in step 256. Finally, the matched code's mode is compared to the current mode in step 258. If the detected mode is the same as the current mode, the mode is maintained in step 252 and coil sets 206 and 212 are configured once more to monitor the rotation of the rotatable member 200 in step 254. However, if the mode is found to be different, the mode is switched in step 260, and coil sets 206 and 212 are configured to rotation monitoring in step 262.

It is known in the art that a coil such as 208, 210, 214 and 216 may be designed and connected to a measurement IC such that the IC may not only obtain inductance-related information from the coils 208, 210, 214 and 216, but also capacitive sensing information. In other words, coils 208, 210, 214 and 216 may be used as capacitive sensing electrodes. In this regard, if the rotating member 200 is made out of an electrically conductive material where its interfering elements 220 and ‘1’ may simply be protruding metallic teeth, then it is possible to achieve the same rotation detection with capacitive sensing. This may be done if the rotating member 200, upon insertion into or attachment onto a main body D, symbolically shown in FIG. 2A, of an electronic device, makes contact with the system's ground. Thus, the interfering elements 220 and the ‘1’ of the code section 204 become grounded targets that affect the capacitance of the capacitive coil electrodes. Furthermore, if the point at which the rotating member 200 makes contact with the electrical ground is a PCB pad or pin on a PCB, said pin or pad may further be connected to the same measurement IC. Then, the measurement IC A may be programmed to either ground the rotating member 200 as for capacitive sensing, or set the pin or pad to a floating potential for inductive sensing.

The embodiment of FIG. 2A may be adapted for quicker and more frequent code detection by the main device. An example of such an adaptation is shown in FIG. 2C, which illustrates a rotating member 270 with a first coil set 272 comprising a first coil 274 and a second coil 276, and also a second coil set 278 comprising a first coil 280 and a second coil 282. Coils 274, 276, 280 and 282 are placed on a main body or member (not shown) is detached or air-gapped from rotating member 270. A key difference from the embodiment of FIG. 2A is that a plurality of regular sections 202 and code sections 204 may be used. Therefore, the embodiment of FIG. 2C is shown to have a first regular section 284a and a second regular section 284b, and also a first code section 286a and a second code section 286b. It should be noted that while FIG. 2C shows an embodiment having only two regular sections 284a and 284b and two code sections 286a and 286b, it is possible to have a larger plurality of these sections. For example, a large rotating member thus having a large circumference may benefit from having five regular sections and five code sections, or more. The embodiment should therefore not be restricted to the number of sections shown in FIG. 2C.

Regarding the angle θ_{code}, it is preferred that the plurality of code sections 286a and 286b are equal and have the same code (not shown here). However, this is not strictly necessary. The first code section 286a may contain a first code (not shown), while the second code section 286b may have second code (not shown). This is advantageous in that when incorporated into the algorithm 230, the first and a second code may both point to the same mode, but there may be sub-functions that are unique depending on which of the codes are read. As such, the algorithm 230 may be adapted by a person of ordinary skill in the art to include a sub-function assignment based on what code is read in addition to assigning the overall mode. Furthermore, while code sections 286a and 286b are shown to both have an angle θ_{code}, this is also not required. The angle of the first code section 286a may be greater than that of the second code section 286b, or vice versa. In general, the restriction of angles remain that θ_{code}<θ_{coil}<θ_{regular}. In other words, any regular section 284a or 284b being of similar or dissimilar angle/size must be such that it is able to cover the angle of the coils (θ_{coil}), thus ensuring a successful handover from one coil set to another when a code section 286a or 286b is to be read. Apart from the adaptation to algorithm 230 mentioned earlier, the algorithm itself is appropriate for use in the embodiment as shown in FIG. 2C.

FIG. 2D shows a sectional side view of the exemplary interfering elements (220) from the regular section 202, or elements ‘1’ of the code section 204, herein denoted by 290; as well as the non-interfering elements (218) from the regular section 202, or ‘0’ elements from the code section 204, herein denoted by 292, of a rotating member 294. In this case, rotating member 294 may be made fully of an electrically conductive material such as aluminum, meaning that interfering elements 290 and non-interfering elements 292 are also made of aluminum. When rotating member 294 is attached to or placed on the main body (D in FIG. 2A) the interfering elements 290 are closest to the coils (not shown) and will then affect their magnetic field. The non-interfering elements 292 will be further away from the coils, and will have a relaxing or non-interfering characteristic. A ‘teeth-like’ approach may thus be taken to implement the regular sections 202 or 284, and code sections 204 and 286. The width of the teeth 290 may be varied according to the width of the coils. The depth 296 of the teeth may be adjusted by the designer of the rotating member 294 such that the interfering effect of interfering elements 290 is maximized relative to any effect of the non-interfering elements 292. In a preferred embodiment, however, the distance 296 is at least equal to or greater than the distance from the coil surface to the surface of an interfering element 290.

Alternative approaches may be taken to the design of the interfering elements. FIG. 2E shows another embodiment of a rotating member 294, where the interfering elements 298, are for example, pieces of ferrite sheet pasted or fixed to the rotating member 294. Said fixing may be achieved by any suitable and cost-effective adhesive as part of the rotating member 294's manufacturing process. The material of the rotating member itself may be, for example, aluminum. In this case, the interfering elements 298 have an enhancing effect, while the non-interfering elements now become ‘reverse’ interfering elements 292 and have a suppressive effect on the inductors (not shown). This embodiment has the advantage of providing high inductive signal range, whilst being more low profile than the ‘teeth-like’ approach in FIG. 2D. Moreover, some of the interfering elements may be made either from a permeable material and others from an electrically conductive material to construct trinary-style code sections 204 (FIG. 2A) have more unique codes than a binary approach.

The rotating member 294 in FIG. 2E may have other combinations of materials. One example is to have the rotating member 294 made of plastic, while the interfering elements 298 are for example made of an electrically conductive material such as copper tape or metal sheet, or a permeable material such as ferrite. Another example is to have the rotating member 294 made of a substrate material such as FR-4 or FPC, while the interfering elements 298 are made of copper pours on the substrate.

Yet another embodiment may be formed by the combination of the concepts disclosed in FIG. 2D and FIG. 2E. For example, if the embodiment in FIG. 2D is 3D printed, the interfering elements 298 may be attached to the teeth 290 of rotating member 294. Furthermore, for example ferrite pieces may be attached to teeth 290 and metal sheets to the cutouts 292, or vice versa.

FIG. 3A shows yet another embodiment of a rotatable member 300 which has two sections, namely a pattern section 302 and a marker section 304. This embodiment uses a single coil set, consisting of a first coil 306a, a second coil 306b and a third coil 306c, instead of two coils as explained in previous embodiments. Coils 306a, 306b and 306c are detached from the rotating member 300, and are placed on a main body (D). The pattern section 302 further comprises a plurality of 3-bit subsections 308, which is either interpreted as a binary ‘1’ as in 308a, or ‘0’ in 308b. Each subsection 308 comprises a first bit 310a, a second bit 310b and a third bit 310c. The first bit 310a in a subsection 308 is known as a start bit. The second bit 310b is referred to as the payload bit, and the third bit 310c is referred to as the stop bit. The first bit 310a and third bit 310c are shown to be ‘0’ and ‘1’ respectively, but may also be chosen to be ‘1’ and ‘0’.

The unique code of the rotating member 300 is constructed from the payload bits 310b, which may either be a logic ‘1’ in the case of subsection 308a, or a logic ‘0’ in the case of subsection 308b. The payload bits 310b are thus embedded into the pattern section 302. A full rotation of the rotatable member 302 is required to read all the payload bits. It is, however, possible to obtain a unique code from, for example, a half or partial rotation if a full rotation is undesirable.

FIG. 3B shows an exemplary, high-level algorithm 320 to extract the complete code from the embodiment of FIG. 3A. As a first step 322 the coils 308a, 308b and 308c are sampled by a measurement IC A. This step may include the processing required to compare the inductance-related values of coils 308a, 308b and 308c to their predetermined thresholds to determine their binary states. Note that for the sake of temperature compensation, said binary states may be obtained by observing the differences between the inductance-related values of coils 308a, 308b and 308c instead, and comparing said differences to their own predetermined thresholds. Subsequently, the measurement IC or a processor B evaluates if any of the binary states related to coils 308a, 308b and 308c have changed based on previously observed state(s) in step 324. If so, then a rotation of the rotatable member 300 is first reported in step 326. If not, the algorithm returns to step 322. In step 328, the measurement IC checks if the detect state of the first coil 306a (COIL1) has detected a logic ‘0’, which denotes the first bit 310a of the subsection 308a or 308b. Additionally, the measurement IC checks if the detected state of the third coil 306c (COIL3) has detected a logic ‘1’, which denotes the third bit 310c of the subsection 308a and 308b. If the requirements of step 328 are met, the measurement IC may conclude that the subsection 308a or 308b is fully aligned with the coils 306a, 306b and 306c, meaning that the payload bit 310b is aligned with the second coil 306b. As such, in step 330 the state of coil 306b which reflects the payload bit 310b may be added to an code-array. Step 332 subsequently checks if the current code-array length is equal to the required code length. If true, the measurement IC may save the current code-array as the unique code for the rotatable member 300 in step 334, and execute or enable unique functions or modes related to the unique code.

Algorithm 320 assumes that the user performs a one-directional rotation on rotating member 300 with pause or stutter such that the payload bits 310b are saved without duplicates. However, a person of ordinary skill in the art can easily modify algorithm 320 to further compensate for a change in rotation direction while the code is still being read, in order to compile the correct code array in step 332.

As indicated the principles of the invention relating to the detection of movement direction of the first member and the extent of movement which is measured by the number of interval changes can be used in a variety of applications e.g. on a camera, a watch, a power tool, an electric tooth brush and so on.

An interval change may correspond with the smallest movement which can be detected by a coil set. Normally this corresponds with a single element of the pattern on the first member.

The detected information is usable in different ways depending on the application and on user requirements. For example:
the speed of operation, rotational or linear as the case may be, in a tooth brush or power tool can be adjusted responsive to the information;
the power output of a device such as an electric screwdriver or a drill can be regulated in that operation of the device is kept under control or within limits;
information output on a display e.g. a screen of a watch, can be varied in light density (brighter or dimmer) or on a size basis (smaller, larger, zoom in, zoom out); and on a device which includes a display screen many options or choices can be presented.

The aforegoing consequences, responsive to information detected, are exemplary and non-limiting.

With reference to FIG. 3A, the marker section 304 is chosen such that the coils 306a, 306b and 306c are still able to derive rotation direction when the marker 304 passes over them. For example, marker section 304 may be ‘1100’. With this marker, the coils 306a, 306b and 306c will observe unique binary transitions that can be used, together with the history of binary states, to derive the direction of rotation. Furthermore, the algorithm 320 may easily be adapted, when the coils 306a, 306b and 306c observe the marker-related states, to reset the code-array to restart the read operation of the unique code. The marker section 304 is shown here to have a length of 4 bits, but may be any number of bits required to retain rotation direction ability while serving as a start-end mark for the pattern section 302 with its embedded code.

In a preferred embodiment, the marker section 304 is omitted, and the pattern section 302 makes up the entire circumference on the rotary member 300. If the code length is known and rotating member 300 is attached to a main body (D) in a predictable and pre-determined manner such that the starting position is also known, then a complete (or partial) rotation of the rotating member 300 directly after attachment onto or insertion into the main body will enable algorithm 320 to successfully read the code without a marker section.

In the foregoing paragraphs, embodiments have been described that either use two sets of two coils or a single set of 3 coils to read a unique code as a rotating member is turned. FIG. 4A relates to another embodiment that uses a single set of 3 or more coils, that is able to read the unique code immediately upon attachment or insertion of a rotating member onto or into a main body and prior to rotation, and thereby also determine the presence of a rotating member. This embodiment will be referred to herein as an instant code embodiment.

FIG. 4A illustrates an exemplary pattern 400 that is suitable for the instant code embodiment. The pattern 400 is shown as a straight line of interfering elements 402 and non-interfering (or reverse interfering) elements 404. However, this is merely to illustrate the detail of the pattern 400 itself, and pattern 400 may have a circular style which is to be placed around a circular rotating member (not shown here) in the same manner as the previously discussed patterns (202, 302) are. The pattern 400 is comprised of a first subsection or code delimiter 406 and a second subsection or unique code 408. The code delimiter 406 and the code 408 are interleaved to make up the entire pattern 400, meaning no other start, end or intermittent sections are required to note the start or the end of the pattern 400 as in pattern 302 in FIG. 3A.

The unique code 408 is shown to be 4 bits, but there may be any number of bits as required by the application. In a preferred embodiment, the number of bits in the code 408 matches the number of coils in the coil set 432 in FIG. 4C. In this way, when the rotating member 420 is placed onto main body 426, the entire unique code 408 is read at once. The goal of the delimiters 406 is to separate the codes 408 in such a manner that rotation direction detection is possible for the measurement IC. It shall be appreciated that while the delimiter 406 is shown to have 3 bits, any number of bits may be used within the delimiter 406 to separate the codes 408 and still retain the ability for rotation direction detection.

The delimiter 406 is typically chosen according to the unique code 408 of a rotating member, to ensure that the sequence of bits is such that rotation direction may be derived. This means that different rotating members having different unique codes 408 will have different delimiters 406. As an example, consider once more FIG. 4A. The exemplary delimiter 406 may be chosen as ‘110’ to match a unique code 408 of ‘0101’ (or simply ‘5’ when the code 406 is evaluated as an integer.). Assuming coil set 432 has four coils to match the size of the code 408, any 4-bit sequence that is read in the pattern 400 will be unique relative to the sequence one bit earlier or one bit further. Now, consider a second pattern having a unique code 412 of ‘1010’ or integer 10. If the delimiter 406 is used with the code 412, repeating four-bit sequences which occur will prohibit direction detection. Thus, a new delimiter 414 is used to match the code 412. More than one delimiter code exists for the code 408. The delimiter 406 or 414 may be determined by simply checking that, given a four-bit sequence read by coil set 432, the four-bit sequence of one interval forward is not equal to the four-bit sequence of one interval backward. This must be true for every possible four-bit sequence read by coil set 432 as the delimiter 402 or delimiter 414 moves over the coil set 432 with the code 408 or 412.

FIG. 4C shows an exemplary embodiment of how an instant code user interface is implemented. A rotating member 420 with a pattern 422 is shown to have protrusions 424A and 424B. A main body 426 is also shown that has keyed slots 428A and 428B. The keyed slots 428A and 428B are designed with the protrusions 424A and 424B to align with each other, such that the rotating member 420 forms a mating pair with the main body 426. The specific alignment of the protrusions 424A and 424B and slots 428A and 428B causes the rotating member 420 to be attached to or inserted into the main body 426 in a specific and predetermined way. A purpose of this restriction is to ensure that a unique code subsection 408 of pattern 400 or 410 fully aligns with the coil set 432 upon attachment or insertion of the rotating body 420 onto or into main body 426. While the embodiment in FIG. 4C is shown to have two protrusions 424A and 424B on the rotating member 420 that align with the two slots 428A and 428B on the main body 426, there can be any number of protrusions and slots that align, thereby enabling the rotating member 420 to be inserted in more than one predetermined way, which then allows more than one code section 408 to be read upon attachment. This aspect is discussed later in this specification. Furthermore, the main body 426 may be outfitted with protrusions 424A and 424B while the rotating member 420 is outfitted with slots 428A and 428B. It shall be appreciated that the mechanical embodiment presented here may be used in the embodiments discussed earlier herein as well.

The main body 426 may have a lip 434 that is off set from the main body surface 436 to form a channel 438 as shown in a sectional view 440. The channel 438 then has the purpose of guiding the protrusions 424A and 424B as the rotating member 420 is rotated after insertion or attachment. The channel 438 has the further purpose of keeping the rotating member 420 attached to main body 426 to prevent it from becoming unintentionally separated from main body 426. Another goal of the channel 438 is to ensure that the vertical distance between the coil set 432 and the pattern 422 remains consistent and restricted as the rotating member 420 is rotated. The key slots 428A and 428B as illustrated here may simply be cutouts in the lip 434 so the protrusions 424A and 424B may enter into the channel 438.

Coil set 432 may be placed on a PCB 442. Alternatively, if wire wound coils are to be used instead of PCB coils, the element 442 may be a ferrite layer that separates the main body surface 436 from the coil set 432. Moreover, if the main body 426 is made from an electrically conductive material such as aluminum, then a ferrite sheet may be placed between the PCB 442 and the surface 436 to shield the coil set 432 from inductive suppression from the body 426.

Coil set 432 is shown to be placed on a horizontal/planar surface 436, but it shall be appreciated that coil set 432 with or without its PCB 442 may be placed in a vertical manner instead. To elaborate, coil set 432 and/or PCB 442 may be placed on a surface 444 instead if it suits the application better. For example, an electric toothbrush or electric screwdriver may not have a sufficiently large horizontal surface 436 because of its long, slender design, in which case a vertical placement on a surface such as the surface 444 would suffice. In this instance, the orientation of the interfering elements 402 and the non-interfering elements (or reverse interfering elements) 404 may be designed such that it overlaps with the surface 444 when the rotating member 420 is attached to the main body 426.

FIG. 4D shows an exemplary algorithm 450 to perform instant code detection in the embodiment of FIG. 4C. In step 452, the coils in coil set 432 are sampled by a measurement IC A or a similar computer module B. If the measurement IC measures a ‘0000’ binary result from the coil set 432 in step 454, it may be concluded that no rotating member 420 is currently attached to the main body 426 in step 456. If the coil set 432 consisted of, for example, five coils, then the check in step 454 would be for ‘00000’. Step 454 is done with the assumption that any code 408 must at least have one interfering element leading to at least one of the coils in coil set 432 to result in a ‘1’. In this way, the device (for example smart watch, camera or electric toothbrush) can determine if a rotating member is present and attached, or not. Steps 452, 454 and 456 are repeated until a rotating member 420 is detected, in which case the code in step 454 would not be ‘0000’ and the measurement IC (and by extension the device) confirms e.g. via an output C (FIG. 2A) the presence of a rotating member 420 in step 458. Upon the detection of the rotating member as part of step 458, the device may activate or de-activate a specific set of features and functions, for example changing power modes now that a rotating member is present. Subsequently, the code 408 may be read in step 460 and the device or measurement IC may check whether the code is valid in step 462. An invalid code may be a result of a counterfeit rotating member, or may be a result of a user attaching a rotating member that is not appropriate or not compatible with the device, for example a detachable camera lens that is not designed to work with the present camera. If the device or measurement IC determines in step 462 that the code is not valid, which may be determined by comparing the presently read code to a list of known codes in the device or measurement IC's memory, the device may for example reject the rotating member by returning to step 456.

If the device or measurement IC determines in step 462 that the code is in fact valid, then a corresponding configuration, settings, functions or features for the device may be loaded in step 464 in addition to the first settings loaded due to step 458. As an example of a function that is loaded in step 464, the device may update a counter to keep track of how many times the specific rotating member was attached to the device, for analytical purposes or to warn the user of replacement due to mechanical wear that occurs over time. Furthermore, the device may further load a separate function according to the code of the rotatable member that keeps track of how many hours the specific rotating member was used, and if the rotating member is a consumable product like a toothbrush head or a tool head, notify the user that a replacement is due.

The coils may be sampled again in step 466 and if a bit change is detected in step 468 in any one of the coils in the coil set 432, a check may be performed in step 470 to verify that the code is not ‘0000’, in which case a rotation may be reported in step 472 which includes for example determining the direction of rotation, speed and acceleration of detection among other rotation-related information. Steps 466, 468, 470 and 472 may be repeated until the coil set 432 has a ‘0000’ result, upon which the device notes that the rotating member has been removed in step 456, and returns to sampling the coils in step 452. As with previous embodiments, differential measurements between the coils may instead by used be used to derive the code from the coil set 432.

It shall be appreciated that while the algorithm 450 illustrates that the code 408 or 412 of a rotating member 420 is read before rotation is reported in step 472, it is a ready adaptation for a person of ordinary skill in the art to modify algorithm 450 such that the code 408 or 412 is read verified in the process of executing steps 466, 468, 470 and 472 as an added step of robustness, especially when the code 408 or 412 are repeated multiple times in a pattern 400 or 410.

The embodiments disclosed hereinbefore are free from the use of magnets. This is especially advantageous for applications that are sensitive to external magnetic fields. However, not all applications are sensitive to magnetic interference, for example cameras, and the present invention may be beneficially augmented with permanent magnets as follows.

Referring once more to the rotating member 294 with teeth-style interfering elements 290 in FIG. 2D, it is possible to replace one or more of the ‘teeth’ with permanent magnets that are approximately the same size as the teeth-style interfering element 290. A first magnet or set of magnets may replace some interfering elements 290 in FIG. 2D, while a second magnet or set of magnets are embedded into the surface 436 of main body, where the second magnet or set of magnets have an attractive effect on the first magnet or set of magnets, such that when the protrusions 424A and 424B align with the slots 428A and 428B of main body, the magnets'attraction will still keep the rotating member 420 attached to the body 426 and accidental decoupling is avoided. The use of a magnet is a feasible replacement for an electrically conductive ‘teeth-like’ interfering element, since specific magnets have conductive coatings that, like electrically conductive interfering elements, can produce eddy-current suppression on the sensing coils and thus produce a detectable signal.

An example of such an embodiment is illustrated in FIG. 5, which may have all the elements described in FIG. 4C, with the addition of magnets 500A and 500B that are embedded into surface 436. In the corresponding position on the rotating member, magnets 502A and 502B are used instead of the normal ‘teeth-like’ interfering elements 290. Magnets 500A and 500B may align with magnets 502A and 502B such that there is an attractive force between magnets 500A and 502A, also between 500B and 502B, upon insertion. This has the benefit that the rotating member 504 remains attached to main body 506, even when the protrusions 508A and 508B align with the slots 510A and 510B during normal use. While FIG. 5 shows the use of two magnet pairs, with the one pair being 500A and 502A, and the second pair being 500B and 502B, the disclosed embodiment may use any number of magnet pairs. For example, only one magnet pair may be used, or several magnet pairs may be incorporated such that magnetic tactile feedback is achieved when an interval change occurs during the rotation of rotating member 504.

In a further embodiment, an extra coil 600 may be placed in addition to the coil set 602. Coil 600 may act as a marker coil, and may be used by the measurement IC (not shown) to derive the absolute position of the rotating member 604. Coil 600 may be distinguished from coil set 602 by having a thin layer of highly permeable material 606, preferably ferrite sheet, placed on the top side of coil 600, which shields it from the interfering elements 290, that is made from electrically conductive material. The rest of the coil set 602 does not have the ferrite shielding of layer 606, and thus functions as described earlier in this invention. Rotating member 604 has at least one magnet 608 that replaces at least one of the interfering elements 290, and magnet 608 may be placed at a pre-determined position (for example 12 o'clock) on the rotating member 604, thus denoting an absolute rotation position. As described earlier, magnet 608 may influence the coil set 602 in the same way as an electrically conductive element would, but is also able to influence coil 600, since the magnetic field of magnet 608 is able to saturate the permeable layer 606, thereby causing a detectable change in coil 600. The measurement IC may thus be programmed to recognize when a predetermined point (i.e. the magnet 608 position) of the rotating member 604 passes over coil 600, by simply monitoring the inductive changes of coil 600, since coil 600 will not be affected by any other interfering elements. Furthermore, by keeping count of the interval changes and rotation direction of rotating member 604 in combination with the state change information of coil 606, absolute rotation of rotating member 604 may be calculated. For example, if rotating member 604 has twelve intervals, and the measurement IC has measured four interval changes that occurred on coil set 602 in a clockwise direction since the last inductance change or state change in coil 600, then the measurement IC may derive that the rotating member 604 is in a 4 o'clock position, thus determining the absolute position. Therefore, this embodiment removes the need for manual user intervention to input a calibration point. Moreover, a person skilled in the art may easily adapt the features of this embodiment to have the measurement IC perform auto-calibration procedures based on the state changes of coil 600.

The embodiments described up to this point have been shown to have one code to be read by coil set. For the embodiment in FIG. 2A, it was disclosed that the code 226 may be captured in pattern section 204, requiring rotating member 200 to be moved for the coil sets 206 or 212 to read code 226. For the embodiment in FIG. 3A, it was disclosed that the code may be embedded in pattern 302 which also requires at least partial rotation of member 300 for the coils 306a, 306b and 306c to read the payload bits 310b. In FIGS. 4A to 4D, an embodiment was disclosed that relies on instant code recognition, thereby not requiring a rotation of member 420. Keeping these embodiments in mind, yet another embodiment is now disclosed that combines the aspects of ‘instant’ code reading and code reading by rotation, by having at least two codes embedded on the pattern of the movable members.

As an example of the above, consider once more the embodiment of FIG. 2A. A first code 228 may be designated on the member 200 anywhere in its pattern. Said designation may be achieved by simply designing the protrusions (not shown) of member 200 to insert into a main body (not shown) such that the first code 228 overlaps with coils 208 and 210 upon attaching member 200 to the main body, thus allowing the instant code recognition of disclosed in the embodiments of FIG. 4. The previously discussed code section 204 now becomes a second code 204, that is read after the first code and requires a rotation. Using at least a first and second code in a member in this manner is beneficial for the application, since a first code 228 may be used to identify specific property of the member (e.g. the color or type), while the second, longer code 204 is read to verify the compatibility, validity or authenticity of the member 200. Checking the compatibility, validity or authenticity may require a longer code sequence, and so having a second code system is beneficial. Nevertheless, any property, validity or authenticity of the first member may be determined by the first or second identification step. Overall, movable member 200 may be seen as a first member, that is exchangeable for a second member having its own first code 228 and second code 204.

As a practical example, consider a watch body that has detachable bezels. The user may attach a blue bezel (first member) to the watch body. At the time of attachment, the first code is read and used by the watch to determine the color of the bezel, thus first identifying a property of the bezel. As the watch bezel is rotated thereafter, a second code is read to perform a second identification; the second identification referring to an authenticity and/or validity check to verify that the bezel is an approved part, and may be used with the watch without compatibility issues. The user may, after some time, remove the blue bezel and replace it with a red bezel (second member), which will undergo a first identification according to its first code and a second identification according to its second code.

As another practical example, consider an electric toothbrush. As with the watch example, the electric toothbrush may have at least two brush heads (first and second members) that are attachable to the toothbrush body. Upon attaching the first brush head, the electric toothbrush performs a first identification, which is to determine the brush type (or other member property) in order to load a specific set of settings. After rotation, a second identification reveals its validity and/or authenticity. The first or the second identification (or both) may be further used to update a timer function that keeps track of the usage time of the particular brush head that is now attached, in order to notify the user that a replacement brush head is due when a predetermined usage limit is reached.

The principle of having a first code and a second code may be extended to the embodiments in FIGS. 3 and 4. For the embodiment in FIG. 3A the first code 312 may be a predetermined section of the pattern 302 that will always be read first by the coils 308a, 308b and 308c upon attachment due to specific placement of protrusions (not shown) in member 300. The second code may then be the made up of a set of payload bits 310b placed within pattern 302. For the embodiment in FIG. 4A, a first code 416 may be designated by the specific placement of protrusions on the movable member. It should be noted that the first code 416 need not be the same as the code section 408, but it can be. The second code may then be a combination of the delimiter 406 and the original code section 408. If pattern 400 is designated to a first member, then the first member may be exchanged for a second member having a pattern 410, said second member having a first code 418 or a first code 412, and a second code that is a combination of 412 and 414.

It shall be appreciated that while the aforementioned embodiments mention a first and second code, it is possible to have a third code and a fourth code and so forth. The number of bits in the first code, given that it's read upon attachment, is typically limited by the number of coils in the coil set, but may be less. For example, the first code may be three bits wide if there are four coils in the coil set. The first code itself need not be separate from the second code, but form part of it. For example, if the first code is code 412, the second code may be comprised of code 412 with the addition of delimiter 414.

The embodiments using the first and second code principle may in fact have a plurality of first codes and a plurality of second codes. This may be achieved if the keyed pair design of the members relative to the main body is such that the first member is attachable in more than one predetermined orientation, which leads to more than one initial first code that is possible. If the second code follows from rotating the member, then a different initial attachment may automatically lead to a different second code as well. This allows the device to launch different functions based on the different first and second codes that are read, depending on the orientation or alignment of member attachment.

1. An electronic user interface device, comprising a main body with a coil set and a first member, which is attachable to the main body and which is movable relative the main body, wherein the first member comprises a first pattern of inductance interfering elements, and the coil set is configured to read a first code embedded in the first pattern upon attachment of the first member to the main body.

2. The electronic user interface device of claim 1, which includes a processor which is configured to perform a first identification of the first member when the coil set reads said first code.

3. The electronic user interface device of claim 1, wherein the main body and the first member comprise a keyed pair to ensure at least one specific alignment between a section of the first pattern on the first member and the coil set at the time of attachment of the first member to the main body.

4. The electronic user interface device of claim 1, wherein the coil set is configured to obtain information regarding movement of the first member relative to the main body.

5. The electronic user interface device of claim 2, wherein the first pattern represents intervals and said information obtained by the coil set includes a number of interval changes upon said movement of the first member, and the direction of said movement of the first member.

6. The electronic user interface device of claim 5, wherein said information of the number of interval changes and of the direction of movement is used to adjust at least one of the following:
a power level of said device;
zoom of said device;
screen brightness of said device;
menu item selection of said device;
a speed of operation of said device.

7. The electronic user interface device of claim 5, wherein the coil set is configured to read a second code embedded in the first pattern thereby to perform a second identification, after a predetermined number of interval changes upon movement of the first member.

8. The electronic user interface device of claim 7, wherein the first or second identification is used to determine at least one of the following:
a. a property of the first member,
b. the validity of the first member,
c. the authenticity of the first member, and
d. the usage of the first member, and wherein a user of said device is notified to replace the first member upon reaching a predetermined usage limit.

9. The electronic user interface device of claim 1, which includes a second member which is exchangeable for the first member, the second member comprising a second pattern of inductance interfering elements, wherein the coil set is configured to read a second code embedded in the second pattern upon attachment of the second member to the main body thereby to determine whether the first or second member is attached to the main body and to change a function of the device in response to said determination with the attached first or second member.

10. The electronic user interface device of claim 5, which includes a processor and wherein at least one of the inductance interfering elements is a magnet, and wherein the main body includes at least one coil with a ferrite covering which is configured to detect the magnet and the processor is configured to use said magnet detection and the number of interval changes to determine a position of the first member relative to the main body.

11. A method of performing inductive code detection in a user interface of an electronic device comprising a main body with a coil set and a first member which includes a first pattern of inductance interfering elements and which is attachable to the main body and which thereafter is movable relative to the main body, said method comprising the steps of attaching the first member to the main body, and then reading a first code embedded in the first pattern of the first member.

12. The method of claim 11, further comprising the step of performing a first identification of the first member upon reading said first code.

13. The method of claim 11, further comprising the step of ensuring specific alignment between a section of the first pattern and the coil set at the time of attachment by designing the main body and the first member to form a keyed pair.

14. The method of claim 11, further comprising the step of obtaining information regarding the movement of the first member relative to the main body in respect of a number of interval changes of the first member, each interval corresponding to a single element of the first pattern, and the direction of movement of the first member.

15. The method of claim 14, further comprising the steps of using said information including the number of interval changes of the first member and the direction of movement of the first member to at least one of the following:
to adjust a power level of said device;
to change a zoom level of said device;
to change a screen brightness of said device;
to change a selected item in a menu of said device;
to change a speed of operation of said device.

16. The method of claim 12 comprising the steps of moving the first member through a predetermined number of interval changes of said first pattern, each interval corresponding to a single element of the first pattern, reading a second code embedded in the first pattern, and performing a second identification relating to the first member.

17. The method of claim 16, further comprising the step of determining a property of the first member based on said first or said second identification.

18. The method of claim 16, further comprising the step, based on said first or said second identification, of determining at least one of the following:
a. validity of the first member,
b. authenticity of the first member,
c. usage of the first member, and then notifying a user to replace the first member when said usage reaches a predetermined limit.

19. The method of claim 11, further comprising the steps of exchanging the first member for a second member which includes a second pattern of inductance interfering elements, attaching the second member to the main body, using the coil set to read a second code embedded in the second pattern, determining whether the first or second member is attached to the main body, and changing a function of the device in accordance with said determination.

20. The method of claim 14, wherein at least one of the inductance interfering elements is a magnet, and wherein the main body comprises at least one coil with a ferrite covering, the method further comprising the step of determining the position of the first member relative to the main body by using the magnet and the number of interval changes of the first member.
